(19) United States
(12) Patent Application Publication
(10) Pub. No.: US 2025/0140994 A1
(43) Pub. Date: May 1, 2025

(54) BATTERY

(71) Applicant: Toyota Jidosha Kabushiki Kaisha, Toyota-shi (JP)

(72) Inventor: Takuya MATSUYAMA, Miyoshi-shi (JP)

(73) Assignee: Toyota Jidosha Kabushiki Kaisha, Toyota-shi (JP)

(21) Appl. No.: 18/746,483

(22) Filed: Jun. 18, 2024

(30) Foreign Application Priority Data
Nov. 1, 2023 (JP) 2023-187493

(51) Int. Cl. H01M 50/124; H01M 10/0525; H01M 10/0562; H01M 50/105; H01M 50/121

(52) U.S. Cl. CPC H01M 50/1245; H01M 10/0525; H01M 10/0562; H01M 50/105; H01M 50/121; H01M 2300/0068

(57) ABSTRACT

The battery includes an electrode body and a laminate outer encasement covering the electrode body, wherein the battery is disposed on an outer side of the laminate outer encasement, covers an entire surface of the laminate outer encasement, and includes a resin member including a polyurea resin, and the average thickness of the resin member is larger than 0.5 mm and smaller than 1.5 mm.

### CROSS-REFERENCE TO RELATED APPLICATION

This application claims priority to Japanese Patent Application No. 2023-187493 filed on Nov. 1, 2023, incorporated herein by reference in its entirety.

### BACKGROUND

### 1. Technical Field

The present disclosure relates to a battery.

### 2. Description of Related Art

A battery such as a lithium-ion secondary battery or the like generally includes an electrode body having a cathode current collector, a cathode active material layer, an electrolyte layer, an anode active material layer, and an anode current collector. The electrode body is sealed in an internal space surrounded by an outer encasing material, for example. Japanese Unexamined Patent Application Publication No. 2020-170583 (JP 2020-170583 A) discloses a laminated secondary battery including a laminated electrode body, a soft laminate outer encasement, and a hard laminate outer encasement.

### SUMMARY

Since performance of batteries deteriorates with overcharging, voltage is normally controlled so that overcharging does not occur. On the other hand, it is also necessary to take measures for when unintended overcharging occurs. When the battery is overcharged, gas is generated from the electrode body. This gas is required to be discharged appropriately to outside of the battery.

The present disclosure has been made in view of the above circumstances, and a primary object thereof is to provide a battery capable of appropriately discharging gas generated at an electrode body to outside of the battery.

[1] A battery includes an electrode body and a laminate outer encasement that covers the electrode body.

The battery includes a resin member that is disposed on an outside of the laminate outer encasement, covering the entire face of the laminate outer encasement, and also containing a polyurea resin.

An average thickness of the resin member is greater than 0.5 mm and smaller than 1.5 mm.

[2] A battery includes an electrode body and a laminate outer encasement that covers the electrode body.

The battery includes a resin member that is interposed between the electrode body and the laminate outer encasement, covering the entire face of the electrode body, and also containing a polyurea resin.
An average thickness of the resin member is greater than 0.5 mm and smaller than 1.5 mm.

[3] The battery according to [1] or [2], in which the average thickness of the resin member is no less than 0.7 mm and no more than 1.3 mm.

[4] The battery according to any one of [1] to [3], in which the electrode body includes a cathode active material layer, an anode active material layer, and an electrolyte layer disposed between the cathode active material layer and the anode active material layer, and the electrolyte layer is a solid electrolyte layer containing a solid electrolyte.

[5] The battery according to [4], in which the solid electrolyte is a sulfide solid electrolyte.

The battery according to the present disclosure has an effect that gas generated from the electrode body can be appropriately discharged to the outside of the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic plan view and a schematic cross-sectional view illustrating a battery according to the present disclosure;

FIG. 1B is a schematic plan view and a schematic cross-sectional view illustrating a battery according to the present disclosure;

FIG. 2A is a schematic plan view and a schematic cross-sectional view illustrating a battery according to the present disclosure;

FIG. 2B is a schematic plan view and a schematic cross-sectional view illustrating a battery according to the present disclosure;

FIG. 3 is a schematic perspective view illustrating an electrode body in the present disclosure;

FIG. 4A is a schematic cross-sectional view illustrating a battery according to the present disclosure

FIG. 4B is a schematic cross-sectional view illustrating a battery according to the present disclosure

FIG. 5A is a schematic cross-sectional view illustrating an electrode body and;

FIG. 5B is a schematic cross-sectional view illustrating an electrode body of the present disclosure.

### DETAILED DESCRIPTION OF EMBODIMENTS

Hereinafter, a battery in the present disclosure will be described in detail with reference to the drawings. Each drawing shown below is schematically shown, and the size and shape of each part are appropriately exaggerated for easy understanding. In addition, in the present specification, a mode in which another member is arranged with respect to a certain member is expressed as follows. When simply referred to as “on” or “below”, unless otherwise noted, it includes both placing other members directly above or below one member and placing other members above or below one member via another member so as to be in contact with one member.

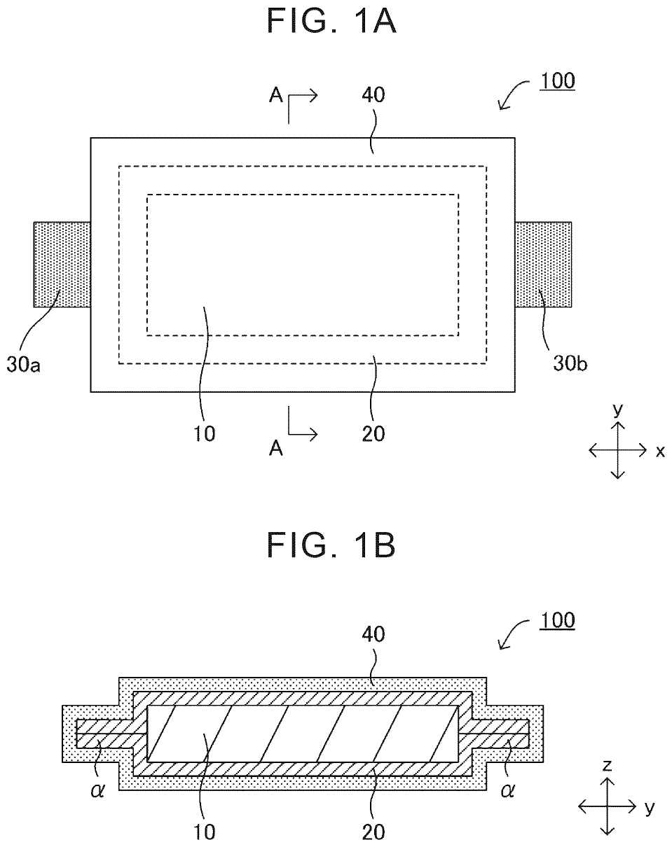

FIG. 1A is a schematic plan view illustrating n battery according to the present disclosure. FIG. 1B is a cross-sectional A-A view of FIG. 1A. The battery 100 shown in FIGS. 1A and 1B has an electrode body 10, a laminate outer encasement 20 covering the electrode body 10, and a terminal 30 electrically connected to the electrode body 10. The battery 100 includes a resin member 40 disposed outside the laminate outer encasement 20. The resin member 40 covers the entire surface of the laminate outer encasement 20 and contains a polyurea resin. Further, in the present disclosure, the average thickness of the resin member 40 is within a predetermined range.

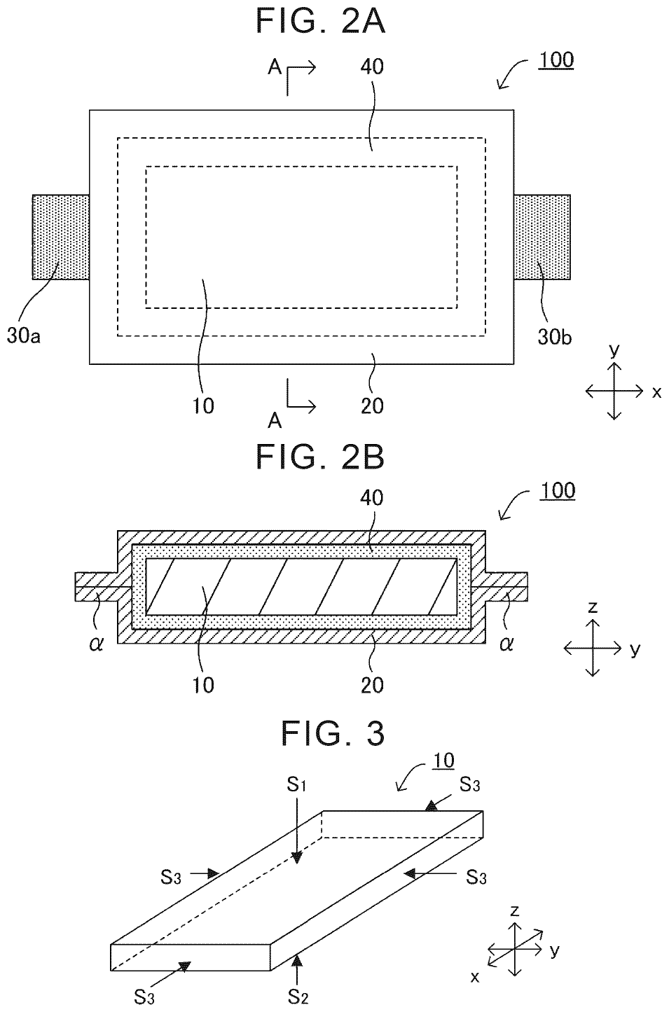

FIG. 2A is a schematic plan view illustrating a battery of the present disclosure. FIG. 2B is a cross-sectional A-A view of FIG. 2A. In the above-described FIGS. 1A and 1B, the resin member 40 is disposed on the outer side of the laminate outer encasement 20. In contrast, the resin member may be disposed inside the laminate outer encasement. Specifically, the battery 100 shown in FIGS. 2A and 2B of the drawing has a resin member 40 disposed between the electrode body 10 and the laminate outer encasement 20. The resin member 40 covers the entire surface of the electrode body 10 and contains a polyurea resin. Further, in the present disclosure, the average thickness of the resin member 40 is within a predetermined range.

According to the present disclosure, by disposing a resin member containing a polyurea resin and having a predetermined average thickness on the outside or the inside of the laminate outer encasement, it is possible to appropriately discharge the gas generated from the electrode body to the outside of the battery. As described above, when the battery is overcharged, gas is generated from the electrode body. This gas is required to be discharged appropriately to outside of the battery.

In the present disclosure, a resin member containing a polyurea resin is disposed on the outer side or the inner side of the laminate outer encasement so as to include the entire electrode body. The polyurea resin has excellent properties such as high elongation, high elasticity, high strength, and high adhesion. Therefore, when the gas is generated from the electrode body, the resin member also expands, and the generated gas can be temporarily stored in the resin member. Accordingly, it is possible to prevent the generated gas from immediately reacting with oxygen in the atmosphere. Further, by appropriately adjusting the average thickness of the resin member, cracks tend to occur in the resin member with increasing internal pressure of the resin member, it is possible to release the gas from the crack. In addition, the polyurea resin has advantages of high chemical resistance, corrosion resistance, flame retardancy, waterproofness, heat resistance, and abrasion resistance. Further, when a resin member containing a polyurea resin is produced, for example, spray coating is used, but in this case, there are advantages such as easy coating over a large area and good workability because the resin member hardens within a few minutes.

### 1. Battery Configuration

The battery according to the present disclosure includes at least an electrode body, a laminate outer encasement, and a resin member.

### (1) Electrode Body

The electrode body according to the present disclosure functions as a power generation element of a battery. Although the configuration of the electrode body is not particularly limited, as shown in FIG. 3, for example, the electrode body has a first surface S₁, a second surface S₂ opposed to the first surface S₁, and a plurality of third surfaces S₃ corresponding to the side surfaces connecting the first surface S₁ and the second surface S₂. Note that, for convenience, in FIG. 3, a description of a tab used for connecting to a terminal is omitted. The first surface S₁ and the second surface S₂ all correspond to the main surface of the electrode body, and the normal direction of the main surface is defined as the thickness direction (z direction).

The shape of the first surface in plan view is not particularly limited, and examples thereof include squares such as a square, a rectangle, a diamond, a trapezoid, and a parallelogram. In FIG. 3, the first surface S₁ has a rectangular shape in plan view. The shape of the first surface may be a polygon other than a quadrangle, or may be a shape having a curve such as a circle. The shape of the second surface in plan view is the same as the shape of the first surface. The shape of the third surface in plan view is not particularly limited, and examples thereof include squares such as a square, a rectangle, a diamond, a trapezoid, and a parallelogram.

### (2) Resin Member

The resin member in the present disclosure is disposed on the outside or the inside of the laminate outer encasement. Hereinafter, a mode (first mode) in which the resin member is disposed outside the laminate outer encasement and a mode (second mode) in which the resin member is disposed inside the laminate outer encasement will be described.

### (i) First Aspect

As shown in FIGS. 1A and 1B, the resin member 40 may be disposed on the outer side of the laminate outer encasement 20. The term “outside of the laminate outer encasement” refers to the side opposite to the electrode body with respect to the laminate outer encasement. By disposing the resin member on the outside of the laminate outer encasement, the resin member can be formed without changing the dimensions of the electrode body and the dimensions of the laminate outer encasement. In addition, the resin member covers the entire surface of the laminate outer encasement. As shown in FIG. 3 described above, when the electrode body 10 has a first surface S₁, a second surface S₂ opposed to the first surface S₁, and a plurality of third surfaces S₃ corresponding to the side surfaces connecting the first surface S₁ and the second surface S₂, the laminate outer encasement is usually arranged so as to cover the entire surface thereof, and the resin member is arranged so as to cover the entire surface of the laminate outer encasement.

In a first aspect, the mean thickness of the resin member is greater than 0.5 mm and less than 1.5 mm. If the average thickness of the resin member is too small, the generated gas cannot be temporarily stored in the resin member, and the generated gas may immediately react with oxygen in the atmosphere. On the other hand, if the average thickness of the resin member is too large, the structural strength of the resin member becomes too high, and it becomes difficult to appropriately discharge the gas generated from the electrode body to the outside of the battery. The mean thickness of the resin member may be greater than or equal to 0.6 mm, greater than or equal to 0.7 mm, or greater than or equal to 0.8 mm. Meanwhile, the mean thickness of the resinous member may be less than or equal to 1.4 mm, less than or equal to 1.3 mm, or less than or equal to 1.2 mm.

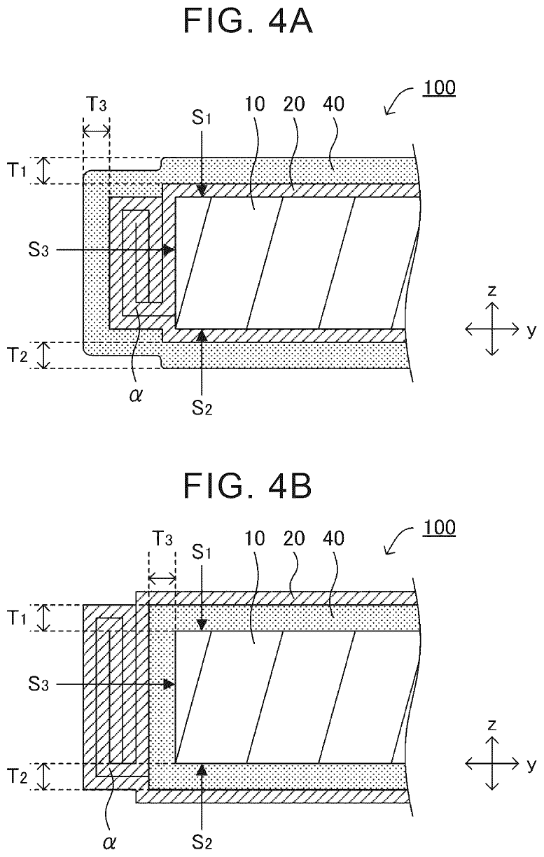

The average thickness of the resin member is determined by the following method. As shown in FIG. 4A, the thickness of the resin member 40 covering the first surface S₁ of the electrode body 10 is T₁, the thickness of the resin member 40 covering the second surface S₂ of the electrode body 10 is T₂, and the thickness of the resin member 40 covering the third surface S₃ of the electrode body 10 is T₃. Here, for a thickness T₁, 10 measurement points are selected without bias, and a thickness T₁ at each measurement point is measured. Next, the maximum value, the second largest value, the minimum value, and the second smallest value are excluded from the measured 10-point thickness T₁, and the mean thickness T_{1AVE} of the thickness T₁ is obtained from the remaining 6 points. A similar procedure is performed for the thickness T₂ and the thickness T₃ to obtain an average thickness T_{2AVE} of the thickness T₂ and an average thickness T_{3AVE} of the thickness T₃. The average of T_{1AVE}, T_{2AVE}, and T_{3AVE} is taken as the average thickness of the resin member.

In the first aspect, T_{1AVE}, T_{2AVE}, and T_{3AVE} are preferably greater than 0.5 mm and less than 1.5 mm, respectively. Further, T_{1AVE}, T_{2AVE}, and T_{3AVE} may be greater than or equal to 0.6 mm, greater than or equal to 0.7 mm, or greater than or equal to 0.8 mm. On the other hand, T_{1AVE}, T_{2AVE}, and T_{3AVE} may be less than or equal to 1.4 mm, less than or equal to 1.3 mm, or less than or equal to 1.2 mm, respectively.

### (ii) Second Aspect

As shown in FIGS. 2A and 2B, the resin member 40 may be disposed inside the laminate outer encasement 20. Specifically, the resin member 40 may be disposed between the electrode body 10 and the laminate outer encasement 20. By disposing the resin member 40 between the electrode body 10 and the laminate outer encasement 20, the resin member 40 functions as a buffer member, and it is possible to prevent the sealing property of the laminate outer encasement from being deteriorated. Specifically, when the volume change of the electrode body 10 occurs with charge and discharge, the stress applied from the electrode body 10 to the laminate outer encasement 20 also changes, so that the sealing property of the laminate outer encasement 20 tends to decrease. On the other hand, by disposing the resin member 40 containing the polyurea resin between the electrode body 10 and the laminate outer encasement 20, the resin member 40 functions as a buffer member, and can absorb the volume change of the electrode body 10 caused by charging and discharging. Therefore, it is possible to prevent the sealing property of the laminate outer encasement 20 from being deteriorated. The resin member 40 covers the entire surface of the electrode body 10. As shown in FIG. 3 described above, when the electrode body 10 includes a first surface S₁, a second surface S₂ opposed to the first surface S₁, and a plurality of third surfaces S₃ corresponding to the side surfaces connecting the first surface S₁ and the second surface S₂, the resin member is disposed so as to cover the entire surface.

In a second aspect, the mean thickness of the resin member is greater than 0.5 mm and less than 1.5 mm. If the average thickness of the resin member is too small, the generated gas cannot be temporarily stored in the resin member, and the generated gas may immediately react with oxygen in the atmosphere. On the other hand, if the average thickness of the resin member is too large, the structural strength of the resin member becomes too high, and it becomes difficult to appropriately discharge the gas generated from the electrode body to the outside of the battery. The mean thickness of the resin member may be greater than or equal to 0.6 mm, greater than or equal to 0.7 mm, or greater than or equal to 0.8 mm. Meanwhile, the mean thickness of the resinous member may be less than or equal to 1.4 mm, less than or equal to 1.3 mm, or less than or equal to 1.2 mm.

The average thickness of the resin member is determined by the following method. As shown in FIG. 4B, the thickness of the resin member 40 covering the first surface S₁ of the electrode body 10 is T₁, the thickness of the resin member 40 covering the second surface S₂ of the electrode body 10 is T₂, and the thickness of the resin member 40 covering the third surface S₃ of the electrode body 10 is T₃. Here, for a thickness T₁, 10 measurement points are selected without bias, and a thickness T₁ at each measurement point is measured. Next, the maximum value, the second largest value, the minimum value, and the second smallest value are excluded from the measured 10-point thickness T₁, and the mean thickness T_{1AVE} of T₁ is obtained from the remaining six points. A similar procedure is performed for the thickness T₂ and the thickness T₃ to obtain an average thickness T₂ T_{2AVE} and an average thickness T_{3AVE} of the thickness T₃. The average of T_{1AVE}, T_{2AVE}, and T_{3AVE} is taken as the average thickness of the resin member.

In the second aspect, T_{1AVE}, T_{2AVE}, and T_{3AVE} are preferably greater than 0.5 mm and less than 1.5 mm, respectively. Further, T_{1AVE}, T_{2AVE}, and T_{3AVE} may be greater than or equal to 0.6 mm, greater than or equal to 0.7 mm, or greater than or equal to 0.8 mm. On the other hand, T_{1AVE}, T_{2AVE}, and T_{3AVE} may be less than or equal to 1.4 mm, less than or equal to 1.3 mm, or less than or equal to 1.2 mm, respectively.

### (3) Laminate Outer Encasement

The laminate outer encasement in the present disclosure is disposed so as to cover the electrode body. As shown in FIGS. 1B and 2B, the sealing portion α is formed by welding the laminate outer encasement 20 opposed to each other, and the electrode body 10 is sealed. Further, as shown in FIGS. 4A and 4B, the sealing portion α may be folded. By folding the seal portion α, the sealing property is improved. In addition, in FIGS. 1B and 2B of the drawings, the two laminate outer encasement 20 are used to seal the electrode body 10. On the other hand, although not particularly shown, the electrode body may be sealed by bending one laminate outer encasement. As a method of welding the laminate outer encasement bodies to each other, for example, a method of pressing a heat bar against a portion where the laminate outer encasement bodies are superimposed on each other and thermally welding the laminate outer encasement bodies to each other is exemplified.

### 2. Member of Battery

The battery according to the present disclosure includes at least an electrode body, a laminate outer encasement, and a resin member.

### (1) Resin Member

The resin member in the present disclosure contains a polyurea resin. The polyurea resin is a resin having a urea bond (—NH—CO—NH—). Examples of the polyurea resin include polyurea and polyurea polyurethane, and among them, polyurea is preferable. Polyureas are generally resins that do not have a urethane bond (—NH—CO—O—), and have the advantage of being less susceptible to hydrolysis than polyurea polyurethanes.

The polyurea is usually obtained by reacting a polyisocyanate with a polyamine. Among them, the polyurea is preferably a resin using only a polyisocyanate and a polyamine as resin raw materials.

A polyisocyanate is a compound having two or more isocyanate groups in one molecule. Examples of the polyisocyanate include diphenylmethane-4,4′-diisocyanate, carbodiimide-modified diphenylmethane diisocyanate, and polymethylene polyphenyl isocyanate. Examples of the polyisocyanate include 2,4-tolylene diisocyanate, 2,6-tolylene diisocyanate, xylylene diisocyanate, hexamethylene diisocyanate, and 3-isocyanatomethyl-3,5,5-trimethylcyclohexyl isocyanate.

The polyamine is a compound having two or more amino groups (primary amino groups or secondary amino groups) in one molecule. Examples of the polyamine include alkaneamines such as ethylenediamine, 1,3-propanediamine, 1,4-butanediamine, 1,3-butanediamine, 1,2-butanediamine, 1,5-pentanediamine, 1,6-hexanediamine, and dimer diamine. Examples of the polyamine include aromatic amines such as o-phenylenediamine, m-phenylenediamine, p-phenylenediamine, 1,5-naphthalenediamine, 1,8-naphthalenediamine, o-xylylenediamine, m-xylylenediamine, and p-xylylenediamine. Examples of the polyamine include polyetheramines such as triethyleneglycol diamine, trimethylolpropane poly(oxypropylene)triamine, and methoxypoly(oxyethylene/oxypropylene)-2-propylamine; and ethyleneamines such as diethylenetriamine, triethylenetetramine, and tetraethylenepentamine. The molecular weight of the polyamine is not particularly limited, but is, for example, not less than 50 g/mol and not more than 1000 g/mol.

In the synthesis of the polyurea, additives such as a chain extender, a crosslinking agent, and a catalyst may be used. Examples of the chain extender include amine-based chain extenders.

On the other hand, the polyurea polyurethane may be, for example, a resin obtained by polymerizing a polyisocyanate, a polyamine, and a polyol-based chain extender. The resin may be a resin obtained by polymerizing a polyisocyanate, a polyol, and an amine-based chain extender.

The glass transition temperature of the polyurea resin is not particularly limited, but is, for example, −50° C. or more and 250° C. or less. The resin member preferably contains, as a resin member, a polyurea resin as a main component, and more preferably contains only a polyurea resin. The elastic modulus of the resinous member is not particularly limited, but may be, for example, greater than or equal to 5 MPa and less than or equal to 30 Mpa, and greater than or equal to 8 Mpa and less than or equal to 15 Mpa. The fracture strength of the resinous member is, for example, 30 kN/m or higher at 25° C. and may be 40 kN/m or higher. On the other hand, the fracture strength of the resinous member is, for example, 100 kN/m or less at 25° C. The fracture strength of the resinous member is, for example, 80 kN/m or higher at −25° C. and may be 100 kN/m or higher. On the other hand, the fracture strength of the resinous member is, for example, 200 kN/m or less at −25° C.

### (2) Electrode Body

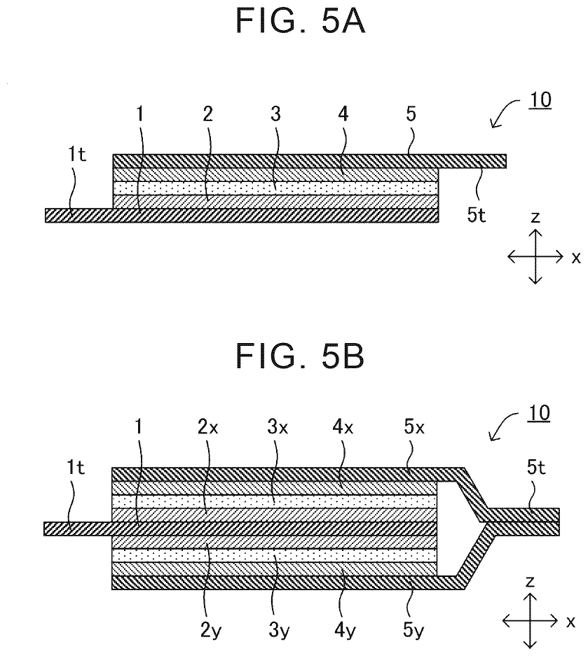

The electrode body in the present disclosure generally includes a positive electrode current collector, a cathode active material layer, an electrolyte layer, a anode active material layer, and a anode current collector in this order in the thickness direction. FIGS. 5A and 5B are schematic cross-sectional views illustrating an electrode body according to the present disclosure, corresponding to a schematic cross-sectional view of the electrode body according to x-z plane in FIG. 3.

The electrode body 10 shown in FIG. 5A includes a anode current collector 1, an anode active material layer 2, an electrolyte layer 3, a cathode active material layer 4, and a cathode current collector 5 in this order in the thickness direction (z direction). The anode current collector 1 has an anode tab 1t for connecting to a negative electrode terminal (not shown), and the cathode current collector 5 has a cathode tab 5t for connecting to a positive electrode terminal (not shown).

The electrode body 10 shown in FIG. 5B includes a anode current collector 1, an anode active material layer 2x, an electrolyte layer 3x, a cathode active material layer 4x, and a cathode current collector 5x arranged in this order in the thickness direction (z direction) from one surface of the anode current collector 1, and an anode active material layer 2y, an electrolyte layer 3y, a cathode active material layer 4y, and a cathode current collector 5y arranged in this order in the thickness direction (z direction) from the other surface of the anode current collector 1.

The cathode active material layer contains at least a positive electrode active material. The cathode active material layer may further contain at least one of an electrolyte, a conductive material, and a binder. Examples of the positive electrode active material include an oxide active material. Examples of the oxide active material include rock salt layered active materials such as LiNi_{1/3}Co_{1/3}Mn_{1/3}O₂, LiNi_{0.8}Co_{0.15}Al_{0.05}O₂, spinel-type active materials such as LiMn₂O₄, and olivine-type active materials such as LiFePO₄. Further, sulfur(S) may be used as the positive electrode active material. The shape of the positive electrode active material is, for example, particulate.

The electrolyte may be a solid electrolyte or a liquid electrolyte. The solid electrolyte may be an organic solid electrolyte such as a gel electrolyte or an inorganic solid electrolyte such as a sulfide solid electrolyte or an oxide solid electrolyte. Among them, the solid electrolyte is preferably a sulfide solid electrolyte. This is because the ion conductivity is high.

The sulfide solid electrolyte usually contains at least an Li element and an S element. It is preferable that the sulfide solid electrolyte further contains an M element (M is at least one of P, As, Sb, Si, Ge, Sn, B, Al, Ga, and In). The sulfide solid electrolyte may contain a halogen element such as F, Cl, Br, or I.

The sulfide solid electrolyte may be a glass-based (amorphous-based) sulfide solid electrolyte, a glass-ceramic-based sulfide solid electrolyte, or a crystalline sulfide solid electrolyte. The sulfide solid electrolyte may have a crystalline phase. Examples of the crystalline phase include a Thio-LISICON type crystalline phase, an argyrodite type crystalline phase, and an LGPS type crystalline phase.

Examples of the composition of the sulfide solid electrolyte include, but are not limited to, xLi₂S·(1−x)P₂S₅(0.5≤x<1), yLiI·zLiBr·(100−y−z)(xLi₂S·(1−x)P₂S₅)(0.5≤x<1, 0≤y≤30, and 0≤z≤30). In these compositions, x preferably satisfies 0.7≤x<0.8. Other examples of the composition of the sulfide solid electrolyte include Li_{7-x-2y}PS_{6-x-y}X_{y}. X is at least one of F, Cl, Br, and I, and x and y satisfy 0≤x and 0≤y. Other examples of the composition of the sulfide solid electrolyte include Li₄₋ₓM₁₋ₓPₓS₄ (0<x<1). M is at least one of Al, Zn, In, Ge, Si, Sn, Sb, Ga and Bi.

On the other hand, the liquid electrolyte contains, for example, a support salt such as LiPF₆ and a solvent such as a carbonate-based solvent. Examples of the conductive material include carbon materials. Examples of the binder include a rubber-based binder and a fluoride-based binder.

The anode active material layer contains at least a negative electrode active material. The anode active material layer may further contain at least one of an electrolyte, a conductive material, and a binder. Examples of the negative electrode active material include a metal active material such as Li, Si, Sn, a carbon active material such as graphite, and an oxide active material such as Li₄Ti₅O₁₂.

The negative electrode active material is preferably a Si active material. This is because it is possible to increase the capacity of the battery. Si active material is an active material containing Si as a main component. Si active material may be a Si alone, may be a Si alloy, or may be a Si oxide. Si active material may have a diamond-type crystal phase, a clathrate I-type crystal phase, or a clathrate II type crystal phase. In a clathrate type I or II crystalline phase, a polyhedron (cage) including a pentagon or a hexagon is formed by a plurality of Si elements. Since the polyhedron has a space in the interior that can contain metallic ions such as Li ions, volume change due to charging and discharging can be suppressed.

The shape of the negative electrode active material is, for example, a particulate shape or a foil shape. The electrolyte, the conductive material, and the binder are the same as those described above.

The electrolyte layer is disposed between the cathode active material layer and the anode active material layer, and contains at least an electrolyte. The electrolyte may be a solid electrolyte or a liquid electrolyte. The electrolyte is similar to those described above. The electrolyte layer may be a solid electrolyte layer containing a solid electrolyte. Further, the solid electrolyte is preferably a sulfide solid electrolyte. In general, a battery having a solid electrolyte layer containing an inorganic solid electrolyte is referred to as an all-solid-state battery.

The positive electrode current collector collects current from the cathode active material layer. Examples of the material of the positive electrode current collector include metals such as aluminum, SUS, and nickel. Examples of the shape of the positive electrode current collector include a foil shape and a mesh shape. The positive electrode current collector usually has a positive electrode tab for connection with a positive electrode terminal.

The anode current collector collects current from the anode active material layer. Examples of the material of the anode current collector include metals such as copper, SUS, and nickel. Examples of the shape of the anode current collector include a foil shape and a mesh shape. The anode current collector usually has a negative electrode tab for connection with a negative electrode terminal.

### (3) Laminate Outer Encasement

The laminate outer encasement in the present disclosure has at least a structure in which an inner resin layer and a metal layer are laminated. In addition, the laminate outer encasement may have an inner resin layer, a metal layer, and an outer resin layer in this order along the thickness direction. Examples of the inner resin layer include olefin-based resins such as polypropylene (PP) and polyethylene (PE). Examples of the material of the metal layer include aluminum, aluminum alloy, and stainless steel. Examples of the outer resin layer include polyethylene terephthalate (PET) and nylon. The thickness of the inner resin layer is, for example, 40 μm or more and 100 μm or less. The thickness of the metal layer is, for example, 30 μm or more and 60 μm or less. The thickness of the outer resin layer is, for example, 20 μm or more and 60 μm or less. The thickness of the laminate outer encasement is, for example, 80 μm or more and 250 μm or less.

### (4) Battery

As shown in FIGS. 1A and 1B, the battery 100 has a terminal 30 (a positive electrode terminal 30a and a negative electrode terminal 30b) electrically connected to the electrode body 10. One end of the positive electrode terminal 30a is electrically connected to a positive electrode tab (not shown) of the electrode body 10 inside the laminate outer encasement 20, and the other end of the positive electrode terminal 30a is exposed to the outside of the laminate outer encasement 20. Similarly, one end of the negative electrode terminal 30b is electrically connected to a negative electrode tab (not shown) in the electrode body 10 inside the laminate outer encasement 20, and the other end of the negative electrode terminal 30b is exposed to the outside of the laminate outer encasement 20. The terminal may be made of a metallic material such as SUS.

The battery in the present disclosure is typically a lithium ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Also, the battery in the present disclosure may be used as a power source for mobile bodies other than vehicles (for example, railroads, ships, and aircraft), and may be used as a power source for electric products such as an information processing device.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

### Example 1

An electrode body including a plurality of cells each having a anode current collector, a anode active material layer, a solid electrolyte layer, a cathode active material layer, and a positive electrode current collector in this order in the thickness direction was produced. As the anode active material layer, a layer containing a negative electrode active material (Li₄Ti₅O₁₂), a binder (PVdF based binder), a sulfide solid electrolyte (Li₂S—P₂S₅ based glass-ceramic), and a conductive material (VGCF) was used. As the cathode active material layer, a layer containing a positive electrode active material (LiNi_{1/3}Co_{1/3}Mn_{1/3}O₂), a binder (PVdF based binder), a sulfide solid electrolyte (Li₂S—P₂S₅ based glass-ceramic), and a conductive material (VGCF) was used. As the solid electrolyte layer, a layer containing a sulfide solid electrolyte (Li₂S—P₂S₅ glass-ceramic) and a binder (butadiene rubber) was used. Further, a Ni foil was used as the anode current collector, and an Al foil was used as the positive electrode current collector.

A positive electrode terminal and a negative electrode terminal were attached to the obtained electrode body, and sealed using a laminate outer encasement (aluminum laminate). Next, a polyurea was applied to the entire surface of the laminate outer encasement by spray coating to form a resinous member (mean thickness 1 mm). As a result, a battery was obtained.

### Example 2

An electrode body was prepared in the same manner as in Example 1. A positive electrode terminal and a negative electrode terminal were attached to the prepared electrode body, and a polyurea was applied to the entire surface of the electrode body by spray coating to form a resinous member (mean thickness 1 mm). Thereafter, the electrode body covered with the resin member was sealed using a laminate outer encasement (aluminum laminate) to obtain a battery.

### Comparative Example 1

Batteries were obtained in the same manner as in Example 1, except that the mean thickness of the resinous member was changed to 0.5 mm.

### Comparative Example 2

Batteries were obtained in the same manner as in Example 1, except that the mean thickness of the resinous member was changed to 1.5 mm.

### Evaluation

The batteries obtained in Examples 1 and 2 and Comparative Examples 1 and 2 were continuously charged at 5.5 C at room temperature and the condition of the batteries were checked. As a result, in Comparative Example 1, the battery was expanded, smoke (white smoke was generated), and then ignited. In Comparative Example 2, the battery expanded, and smoke and ignition occurred simultaneously. On the other hand, in Examples 1 and 2, although the battery was expanded and smoked, it was then extinguished and did not ignite. As described above, it was confirmed that the gas generated from the electrode body can be appropriately released to the outside of the battery by disposing a resin member containing a polyurea resin and having a predetermined average thickness on the outside or the inside of the laminate outer encasement.

What is claimed is:

1. A battery, comprising: an electrode body; and a laminate outer encasement that covers the electrode body, wherein
the battery includes a resin member that is disposed on an outside of the laminate outer encasement, covering an entire face of the laminate outer encasement, and also containing a polyurea resin, and
an average thickness of the resin member is greater than 0.5 mm and smaller than 1.5 mm.

2. A battery, comprising: an electrode body; and a laminate outer encasement that covers the electrode body, wherein
the battery includes a resin member that is interposed between the electrode body and the laminate outer encasement, covering an entire face of the electrode body, and also containing a polyurea resin, and
an average thickness of the resin member is greater than 0.5 mm and smaller than 1.5 mm.

3. The battery according to claim 1, wherein the average thickness of the resin member is no less than 0.7 mm and no more than 1.3 mm.

4. The battery according to claim 2, wherein the average thickness of the resin member is no less than 0.7 mm and no more than 1.3 mm.

5. The battery according to claim 1, wherein:
the electrode body includes a cathode active material layer, an anode active material layer, and an electrolyte layer disposed between the cathode active material layer and the anode active material layer; and
the electrolyte layer is a solid electrolyte layer containing a solid electrolyte.

6. The battery according to claim 2, wherein:
the electrode body includes a cathode active material layer, an anode active material layer, and an electrolyte layer disposed between the cathode active material layer and the anode active material layer; and
the electrolyte layer is a solid electrolyte layer containing a solid electrolyte.

7. The battery according to claim 5, wherein the solid electrolyte is a sulfide solid electrolyte.

8. The battery according to claim 6, wherein the solid electrolyte is a sulfide solid electrolyte.
